(19) United States
(12) Patent Application Publication
(10) Pub. No.: US 2016/0063520 A1
(43) Pub. Date: Mar. 3, 2016

(54) System for Analyzing Patterns

(71) Applicant: BANK OF AMERICA CORPORATION, Charlotte, NC (US)

(72) Inventors: Debashis Ghosh, Charlotte, NC (US); Sudeshna Banerjee, Waxhaw, NC (US); Shiba Madaan, Charlotte, NC (US); Sreedevi Gummuluri, Charlotte, NC (US); David Joa, Irvine, CA (US)

(21) Appl. No.: 14/936,002

(22) Filed: Nov. 9, 2015

Related U.S. Application Data
(63) Continuation of application No. 12/574,418, filed on Oct. 6, 2009.

(51) Int. Cl. G06Q 30/02

(52) U.S. Cl. CPC G06Q 30/0201

(57) ABSTRACT

A data analyzer associated with an entity determines patterns and/or sequences in user data. The analyzer may provide businesses with feedback on spatiotemporal patterns in user habits. In certain embodiments, the analyzer determines the frequency of a sequence of purchases made at a first entity immediately followed by purchases made at a second entity. In another embodiment, the analyzer determines trends in user purchases made during the weekday versus those that are made during the weekend. The results of the analysis may be used in a variety of ways, including, but not limited to merchant/consumer prospecting, and targeted promotions.

### CROSS-REFERENCE TO RELATED APPLICATIONS

This application is a continuation of and claims priority to copending U.S. patent application Ser. No. 12/574,418, filed Oct. 6, 2009, and entitled “Analyzing Patterns Within Transaction Data,” which is related to U.S. patent application Ser. No. 12/475,908, filed Jun. 1, 2009, and U.S. patent application Ser. No. 11/740,130, filed Apr. 25, 2007. The contents of all of these applications are incorporated herein by reference in their entirety.

### TECHNICAL FIELD

Aspects of the invention generally relate to systems for analyzing data. In particular, various aspects of the invention include systems for analyzing data to identify patterns that may be used to generate recommendations to entities for increased profitability.

### BACKGROUND

Currently, entities use research firms or consultant firms to help identify trends in consumer behaviors. These firms may cold-call a list of previously registered focus group participants to prequalify prospects for sponsored research studies. Online research companies have performed services similar to offline research companies with the notable difference that the survey and focus group studies may be conducted online. Much as their offline counterparts maintain a list of prospects, online research companies may use the internet to recruit and qualify focus group participants and survey takers. Partnerships and ventures between manufacturers, airlines, and research companies are a more recent evolution of companies engaged in research. In such a partnership, a company with a base of consumers may make its consumer base accessible to research companies.

Finally, targeted efforts may rely on a list of users who also fit pre-defined criteria. List brokers source prospects in various ways, sometimes without the consent and/or knowledge of individuals. For example, a person entering a sweepstakes at a shopping mall could eventually have his or her contact information in a list aggregator's database. The list aggregator would in turn sell this information to companies, small businesses, non-profit organizations, and individuals for a fee.

All of these third party sources of information might not have access to actual user historical data when trying to analyze consumer habits at various entities. Therefore, the results of the analysis from these sources might not be as reliable as it would be if actual user data were used.

Even if an entity provides sales information, a financial entity is often aware of the information only after the entity publically releases it. Consequently, a financial entity may first recognize that the entity has issues only after investing in the entity. Moreover, entities that are privately-held may not publically release sales information at all.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing systems, methods, computer readable media, and apparatuses including one or more analyzers interfacing with one or more databases to analyze and process data to identify patterns in user behaviors. The analysis system or tool may receive and analyze data to identify geographical sequences in the data to help entities understand how users move from one acquisition to another.

With another aspect of the disclosure, by analyzing data of an entity by entity location, a financial institution may better assess the security of an entity. The financial institution may subsequently evaluate different value propositions that may be offered to the entity or a user.

With another aspect of the disclosure, a financial institution may use the analysis tool to prospect for new business clients.

With another aspect of the disclosure, data for different entities and different geographic areas can be compared to identify potential customers.

Aspects of the disclosure may be provided in a computer-readable medium having computer-executable instructions to perform one or more of the process steps described herein.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements and in which:

FIG. 1 shows an illustrative operating environment in which various aspects of the disclosure may be implemented.

FIG. 2 is an illustrative block diagram of workstations and servers that may be used to implement the processes and functions of certain aspects of the present disclosure.

FIG. 3 shows a system for accessing and analyzing transaction data in accordance with an aspect of the disclosure.

FIG. 4 shows a flow diagram for analyzing spatiotemporal patterns in transaction data in accordance with an aspect of the disclosure.

FIG. 5 shows a block diagram of the transaction data pattern analyzer in accordance with an aspect of the disclosure.

### DETAILED DESCRIPTION

As discussed above, there are problems associated with the use of market research firms and other related entities in providing services related to analyzing trends in consumer spending habits. Financial institutions have large stores of transaction data through credit or debit card spending. Thus, they may leverage this data by directly providing transaction data-related analysis services to consumers and/or merchants.

In accordance with various aspects of the disclosure, methods, computer-readable media, and apparatuses are disclosed in which a financial entity analyzes sequences in consumer transaction data. A financial institution, e.g., a bank, may use aspects of the disclosure to analyze spatiotemporal patterns in consumer transaction data. To provide this service, a financial entity may provide its data store of transaction data to an analysis processor for determining patterns in consumer spending habits. Examples of patterns that may be analyzed include those related to weekend or weekday purchases, geographical sequences such as visits to one merchant in one location followed by another merchant in a second location, and/or any number of other metrics that may be of interest.

In the example above, distance is one metric that is studied by the financial entity. In analyzing how consumer purchases at different merchants are related to one another in distance, the financial entity may be interested in the frequency of purchases made by the same consumer at two different merchants located within a certain radius of one another. Alternatively, the financial entity may be interested in further defining a particular product combination sold at the two different merchant locations. For instance, the combination purchase of baby diapers at a retail store followed by toys at a toy store may be used to better understand how physical separation plays a role in promoting the purchase of these two items. In yet other embodiments, purchase combinations at more than two locations may be studied at the same time. In addition, within these sequences of purchases at multiple locations, more than one purchase at a single location may be studied. In this example, a financial entity may be interested in the combination purchase of baby diapers and clothes at a retail store followed by the purchase of toys at a toy store.

In other examples, time is the metric that is studied by the financial entity. In analyzing how consumer purchases are related to one another in time, the financial entity may be interested in the frequency of purchases made by the same consumer at two different merchants within a certain time of one another. Alternatively, as with distance, the financial entity may be interested in further defining a particular product combination sold at the two different merchant locations within a certain time of one another. In yet other embodiments, purchase combinations at more than two locations with multiple time intervals may be studied.

In other embodiments, more than one metric may be studied at the same time. For instance, a financial entity may be interested in how closely consumer purchases at different merchants are related to one another both in distance and in time. In addition, the financial entity may be interested in how the frequency of such sequences of purchases at different merchants changes over the course of the week. In yet other embodiments, sequences of purchases occurring at many merchants over varying time periods may be analyzed. This information may be used to better align the business posture of a merchant to the changing needs of consumers. For example, if the analysis resulted in conclusions that support the sale of one product over another on certain weekdays, the merchant may increase the visibility of that product or include more models for selection by consumers.

In certain embodiments of the disclosure, a transaction analyzer tracks every consumer transaction in real-time and constantly updates a pattern of purchases based on new data. For instance, if a dramatic sales drop occurred at a certain clothing store during the course of a month, the transaction analyzer would be able to flag this change and may also be able to offer insight into reasons for why the change occurred in the first place.

In return for offering this information to a merchant, the merchant may decide to partner with the financial entity by processing all of his transactions through the financial entity payment network, thus resulting in a two way benefit both for the financial entity and the merchant. Alternatively, the financial entity may charge merchants for providing them with this information.

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

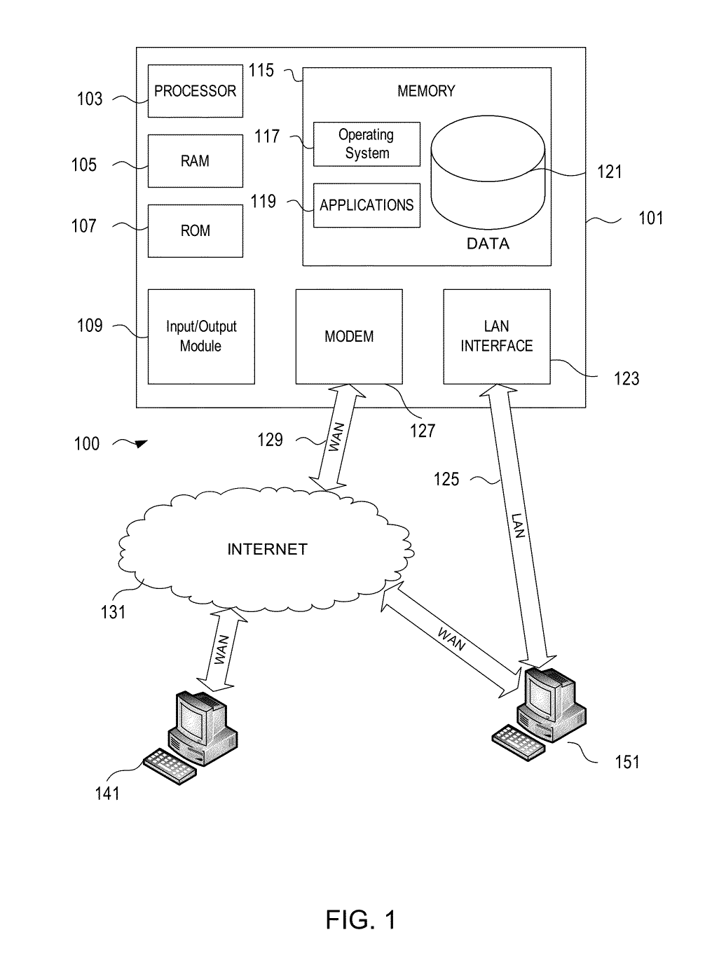

FIG. 1 illustrates a block diagram of a generic transaction data analyzer 101 (e.g., a computer server) in communication system 100 that may be used according to an illustrative embodiment of the disclosure. The analyzer 101 may have a processor 103 for controlling overall operation of the analyzer and its associated components, including RAM 105, ROM 107, input/output module 109, and memory 115.

I/O 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling analyzer 101 to perform various functions. For example, memory 115 may store software used by the analyzer 101, such as an operating system 117, application programs 119, and an associated database 121. Processor 103 and its associated components may allow the analyzer 101 to run a series of computer-readable instructions to sequence consumer transaction data according to the type of analysis that a user may request. For instance, if a user requests that transaction data for consumers aged 20-39 within Chicago should be analyzed based on the number of purchases for winter coats at a clothing store followed by snow boots in a shoe store, analyzer 101 would access the transaction database of the financial entity that represents consumers of these stores, extract the relevant transaction records based on age, location, and types of purchases made in sequence, and run these extracted transaction records through a sequence algorithm stored in memory 115 and run by processor 103.

The analyzer 101 may operate in a networked environment supporting connections to one or more remote computers, such as terminals 141 and 151. The terminals 141 and 151 may be personal computers or servers that include many or all of the elements described above relative to the transaction data analyzer 101. Alternatively, terminal 141 and/or 151 may be a transaction data store associated with a financial entity and accessed by analyzer 101. The network connections depicted in FIG. 1 include a local area network (LAN) 125 and a wide area network (WAN) 129, but may also include other networks. When used in a LAN networking environment, the analyzer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the analyzer 101 according to an illustrative embodiment of the disclosure may include computer executable instructions for invoking functionality related to finding patterns in and sequencing consumer transaction data.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

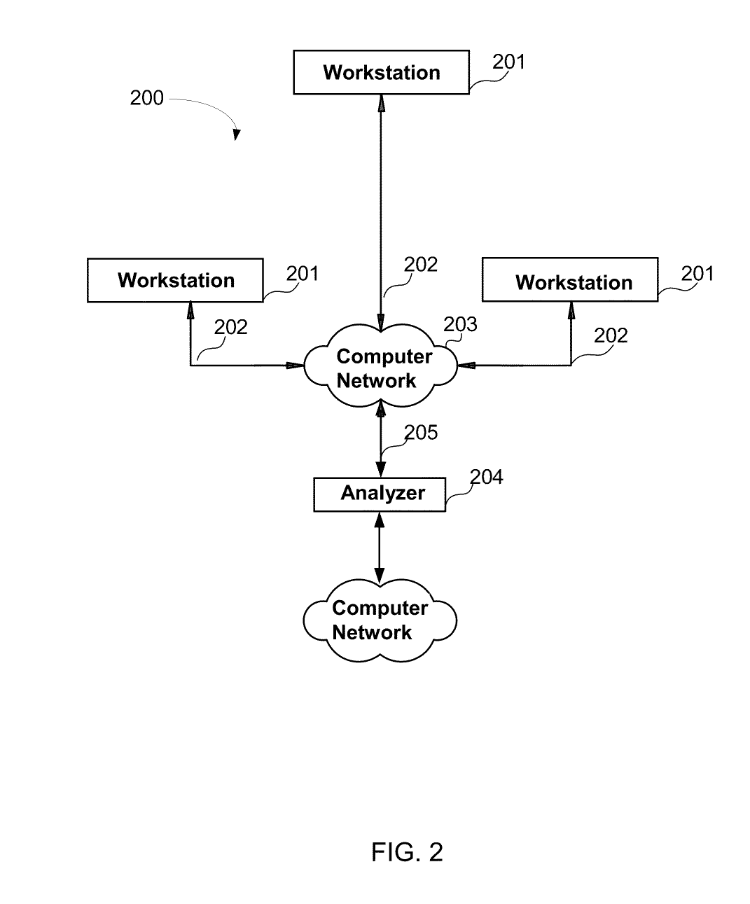

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to transaction analyzer 204. In certain embodiments, workstations 201 may be different consumer transaction data stores or in other embodiments workstations 201 may be different points at which the transaction analyzer may be accessed. In system 200, transaction analyzer 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

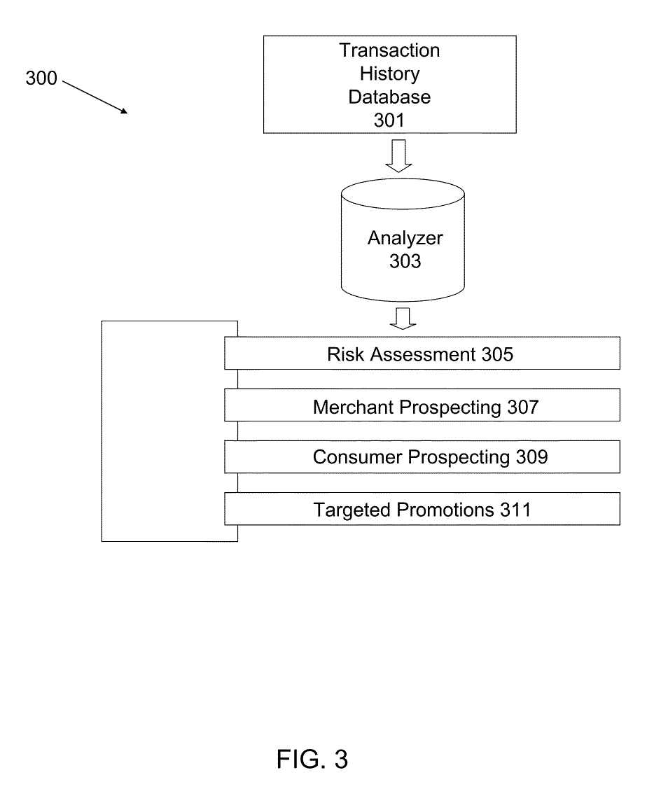

FIG. 3 shows system 300 for analyzing sequences in transaction data in accordance with an aspect of the invention. System 300 includes transaction history database 301 that stores transaction information. Database 301 may store transaction history including debit card, credit card, and other purchase/bill payment entries for customers of a financial institution. Transaction analyzer 303 interfaces with database 301 and analyzes consumer spending habits using pattern recognition and sequence algorithms.

As mentioned above, the patterns or sequences discovered by analyzer 303 may include any number of analysis functionalities. For instance, a merchant with a credit line through the financial entity may be interested in types of purchases made by consumers during weekend store hours versus those made during weekday hours. This information may be used by the merchant to better stock and display products in her store to maximize profits during different times of the week. If such an analysis is to be performed, a user may input a merchant ID number or store name to the transaction analyzer 303 to pull up all the transaction records that correspond to the merchant. Then a user may provide an input that reflects the type of pattern that needs to be recognized; in this case, a user may indicate that results are to be separated based on weekend versus weekday purchases. To perform this type of study, a user may select a predefined field on a display screen that indicates that this type of study is to be performed; alternately, a user may have to type in a code related to this type of study.

After the relevant input information has been provided to analyzer 303, analyzer 303 may access the transaction database 301, extract the transaction records that correspond to the relevant merchant, and group the purchases made at the merchant on weekdays versus the weekend. If a user had provided a range of dates for which consumer transactions are to be analyzed, analyzer 303 may extract the transactions for a merchant only during that particular time period. If no dates were provided, analyzer 303 may use an arbitrary range of dates; for instance, transactions during the past month or the past year may be accessed. In yet other embodiments, the transaction analyzer 303 may access the full range of available dates within database 301.

In addition, a user may provide other inputs to further define the type of output that she desires. For instance, a user may require that the weekday/weekend purchase pattern may be further divided into the quantity of specific products sold on each day of the week. Alternatively, a user may wish to compare weekday versus weekend product sales of only one or two particular products. Any number of other inputs may be provided to analyzer 303 to further define either the type of analysis that analyzer 303 undertakes or the type of output that analyzer 303 provides.

Once analyzer 303 generates an output based on the input parameters that define the analysis, the results may be used for any number of applications by the financial entity, including risk assessment 305, merchant prospecting 307, consumer prospecting 309, and/or targeted promotions 311. If a user decides to use the output of analyzer 303 for a risk assessment study 305, the tool may provide quick insights into any change in the spending trends at various businesses, thereby highlighting the businesses that are losing/gaining customers. For instance, if consumers have moved from one retailer to another, all else being equal, this shift could signal a quality change in the products being sold by the merchant or a change in management which is resulting in the customer being dissatisfied. The additional information may help a financial entity better manage the credit line of the merchant.

Alternatively, if a user decides to use the output of analyzer 303 for merchant prospecting 307 and/or consumer prospecting 309, this tool may help identify new merchants that are becoming popular with consumers associated with the financial entity. The financial entity may then partner with the merchant to provide valuable insights that may help improve the business. If a user decides to use the output of analyzer 303 for targeted promotions 311, the tool may help identify consumers that should receive pamphlets or flyers that relate to a particular product or service. For instance, analyzer 303 may identify individuals who purchase tennis shoes on a regular basis; therefore, rather than mass-mailing all consumers in their database, an outlet mall may send coupons, sales, and new model information directly to this target audience.

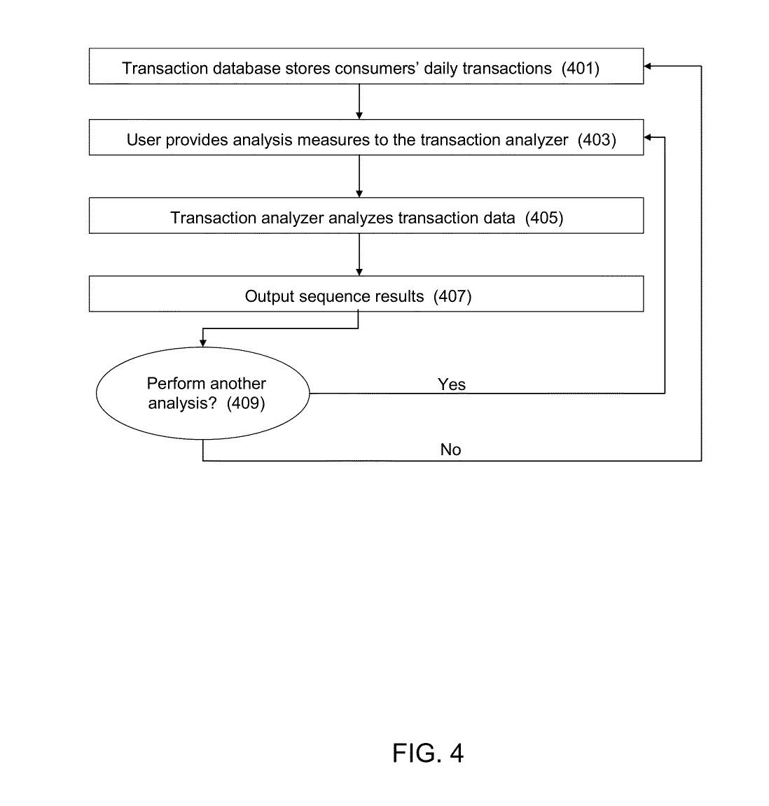

FIG. 4 shows a flowchart depicting a method for analyzing spatiotemporal sequences in transaction data in accordance with an aspect of the invention. The method starts out at step 401 where a transaction database stores consumers' daily transactions. The process then moves to step 403 where analysis measures are provided to the transaction analyzer 303. As discussed above, the precise inputs provided to the analyzer 303 depends on the type of analysis requested. For instance, for an analysis that tries to compare the purchase of groceries at a particular location with movie rentals at another location, the inputs provided to analyzer 303 may include a grocery store identifier, a movie rental store identifier, transaction date range, and any other variables that a financial entity may want to use to further limit the output of the analysis.

The method then moves to step 405 where the transaction analyzer 303 analyzes the transaction data limited by the inputs provided in the previous step. In this step, analyzer 303 may access computer readable instructions that allows it to group consumer transactions based on the inputs. For instance, in the example of a the grocery purchase followed by a movie rental, analyzer 303 may run through each consumer's transaction list at the grocery store specified and check to see if a movie rental at the rental store also specified followed the visit to the grocery store. If a movie rental at the store indicated followed the purchase of groceries (perhaps within a maximum of 30 minutes following the purchase of groceries), then analyzer 303 may make note of this through the setting of a flag or by increasing a count within a computer memory 115. Alternatively, analyzer 303 may copy the relevant transaction entries that correspond to this purchase sequence to a computer memory 115.

The process then may move to step 407 where the analysis results are output to a user. If a user requests another analysis, the process moves back up to step 403 where a user inputs new analysis parameters. If no new analysis is requested, the process resets back to step 401.

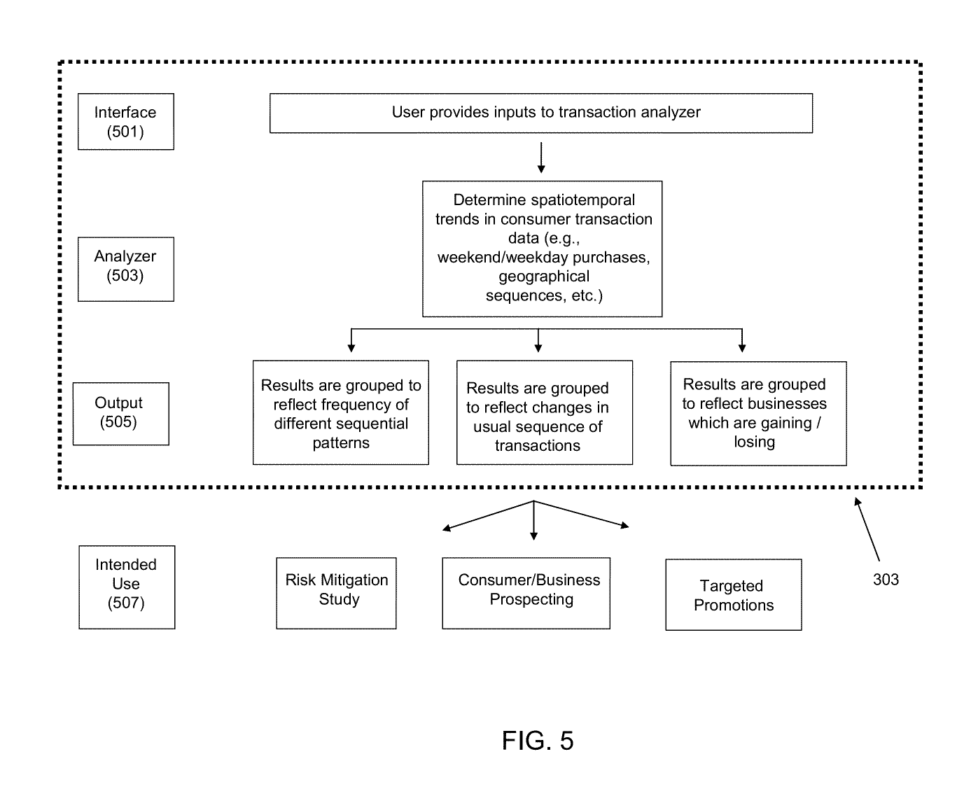

FIG. 5 shows a block diagram of a transaction data pattern analyzer system in accordance with an aspect of the disclosure. The transaction data analyzer system 303 includes a user interface 501, the core analyzer 503, and an output module 505. User interface 501 may include one or more of the options discussed above for input/output module 109. Meanwhile, the core analyzer 503 may include elements such as processor 103, RAM 105, ROM 107, memory 115, and/or modem/interfaces 123 and 127. As discussed above, memory 115 in analyzer 503 may include software to provide instructions to processor 103 for enabling analyzer 503 to perform calculations related to analyses such as determining the frequency of transactions by a consumer at one merchant relative to those made by the consumer at another location. This software may also enable processor 103 to perform multidimensional analyses such as those based on frequencies of purchases made at various merchants based on specified distances between merchants and specified intervals of time between purchases. To perform these calculations, the software within memory 115 may instruct the analyzer 503 to access transaction data at regular intervals and/or may include an instruction to flag transaction data of a particular consumer when a new purchase relevant to an existing analysis has been made. Thus, updates to any analyses may include the most current data and results of these analyses may be made available in real-time. Finally, output module 505 may comprise similar features as user interface 501.

With user interface 501, a user may provide inputs to the transaction analyzer system 303. As indicated above, the inputs may be dependent on the type of analysis being conducted. Once inputs are provided by interface 501, analyzer 303 analyzes the spatiotemporal trends in consumer transaction data. As discussed above, analyzer 503 performs this analysis by accessing a transaction database 301 associated with a financial entity and extracting transaction information relevant to the analysis being performed.

Once the core analyzer 503 performs a pattern analysis on the transaction data, the output module 505 may output the results of the analysis in a variety of ways, some of which are detailed in FIG. 5. For instance, the results may be grouped to reflect frequency of different sequential patterns. As an example, if multiple geographical sequences of purchases are analyzed, then each sequence is output with an appropriate occurrence count in the data analyzed.

Alternatively, results may be grouped to reflect changes in the usual sequence of transactions. For instance, if a sequence of purchases at a grocery store followed by movie rentals changed from occurring at a higher frequency at one rental store compared to another, this change may be flagged by the core analyzer 503 and output along with other changes. Again, this change may signal a quality change in one rental store versus the other. In addition, the change may be used by the financial entity to form partnerships/extend credit with the rental store gaining market share. To flag the unusual sequence change, the frequency of occurrence may have to shift over a certain threshold value. This threshold value may be hardwired into the core analyzer 503 or may be set by the user.

In yet another embodiment, results may be grouped to reflect businesses which are gaining/losing market share. For instance, if one retail store has quarterly sales that exceed a certain threshold value compared to previous quarters, this retail store may be flagged. Further, if nearby stores are losing market share with respect to the one that is gaining market share, those stores may also be flagged and output along with the one that is gaining market share.

The use 507 of the output module 505 may reflect a wide variety of purposes. As mentioned earlier, some potential uses include risk mitigation, merchant/consumer prospecting, and targeted promotions.

As another example, consider that a financial entity is interested in understanding the trends of purchases made at local a furniture store followed by purchases made at a hardware store located within a two mile radius of the furniture store. Both of these merchants have applied for credit at the financial institution and have seen their profits shrinking in the last two fiscal quarters. Thus, the financial institution may be interested in this sequence of purchases for a variety of reasons. For example, perhaps the financial institution would like to understand whether or not there is an overlap of consumers between the furniture and hardware markets. Alternatively, the financial institution may desire to understand whether the perceived distance between the two stores is contributing to a decline in sales at either merchant.

Regardless of the purpose of the analysis, assume that in one embodiment a transaction analyzer at the financial institution accesses a consumer transaction storage database associated with the furniture store and the hardware store. In accessing the storage database, the analyzer may extract transaction entries of consumers that have purchased items at the furniture store within an hour or so of purchases made at the hardware store. Assume that in this example, the information extracted includes an id that masks the consumer's name, the transaction amount at each store, and the time elapsed between purchases at the two stores. In other cases, other types of information may be extracted based on the type of study being done. For example, in certain analyses, only the frequency of purchases may be required or in others only the transaction total.

Assume that the table below summarizes the transactions extracted for two consumers, identified as consumers 112 and 532. Notice that along with the consumer ids, the transaction amounts and the timestamp information at both merchants is listed. If these entries were the only two that are pulled from the transaction history database, the analyzer would then calculate the frequency of this sequence (2) and the total amount purchased under this sequence ($123.56+$4.32+$55.23+$9.47=$192.58).

TABLE 1
Sample Transaction Analysis Performed by Transaction Analyzer

| | | Hard- | Date/Time of | Date/Time of |
|---|---|---|---|---|
| Consumer | Furniture | ware | Transaction at | Transaction at |
| Identifier | Store | Store | Furniture Store | Hardware Store |
| 112 | $123.56 | $4.32 | 9/20/2009 at 2:23pm | 9/20/2009 at |
| | | | | 3:06pm |
| 532 | $55.23 | $9.47 | 9/14/2009 at 4:19pm | 9/14/2009 at |
| | | | | 3:25pm |

The financial institution may then use the results of this analysis to provide the two merchants with information regarding how they may work together to improve sales at each store. In the example above, the financial institution may conclude that the small number of consumers and the relatively small amount of purchases resulting from consumers moving between the furniture and hardware stores signals a lack of connection between the two markets. Alternatively, the results of this analysis in conjunction with other data showing that an even closer distance between two similar types of merchants produces many more purchases occurring between the two merchants may cause the financial institution to recommend that one of the merchants move from their current location to one that is closer to the second merchant. As one of ordinary skill in the art would appreciate, the number and types of conclusions drawn from these results are limitless.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A system for analyzing sequences in data, comprising:
a transaction history database;
a display; and
a core analyzer, having a processor and memory storing instructions that, when executed, cause the core analyzer to:
(i) receive analysis measures used to identify types of information within the transaction data for analysis;
(ii) access the transaction history database to obtain a first transaction data set detailing purchases made by a user at a first entity location, the user being a customer of an organization;
(iii) extract, from the transaction history database, the first transaction data set, the first transaction data set including data of the types identified based on the received analysis measures;
(iv) access the transaction history database of the system for analyzing sequences in data to obtain a second transaction data set detailing purchases made by the user at a second entity location within a maximum time of the purchases made in the first transaction data set at the first entity location and within a specified distance of the first entity location at which the purchases were made in the first transaction data set;
(v) extract, from the transaction history database, the second transaction data set, the second transaction data set including data of the types identified based on the received analysis measures;
(vi) calculate a frequency with which the purchases in the first transaction data set are made within the maximum time and the specified distance of the purchases made in the second transaction data set by the user; and
(vii) generate an output with an indicator of the frequency with which the purchases in the first transaction data set are made within the maximum time and the specified distance of the purchases made in the second transaction data set by the user,
wherein the output is provided on the display and wherein the output is grouped to reflect changes in a usual frequency with which the purchases in the first transaction data set are made within the maximum time and the specified distance of the purchases made in the second transaction data set by the user to determine a relationship between the first transaction data set and the second transaction data set.

2. The system of claim 1 further comprising repeating steps (i) to (vii) for each user at the first entity location.

3. The system, of claim 1 further including instructions that, when executed, cause the core analyzer to:
identify, based on the output, a potential improvement for at least one of the first entity and the second entity; and
transmit the identified potential improvement to at least one of the first entity and the second entity, wherein the potential improvement includes at least one of:
prospecting for new users of an entity and generating targeted notification for users.

4. The system of claim 1, wherein the specified distance is hard-wired into a memory associated with the system for analyzing sequences in transaction data of an organization.

5. The system of claim 1, wherein the maximum time is hard-wired into a memory associated with the system for analyzing sequences in transaction data of an organization.

6. The system of claim 1, wherein the maximum time is specified by a user.

7. The system of claim 1, wherein the specified distance is specified by a user.

8. A computer-assisted method comprising:
(i) receiving, by a transaction history database of a system for analyzing sequences in transaction data of an organization, transaction data for customers of the organization, the transaction data including transactions conducted at a plurality of entities;
(ii) receiving, by a core analyzer of the system, analysis measures used to identify types of information within the transaction data for analysis;
(iii) accessing, by the core analyzer of the system, the transaction history database to obtain a first transaction data set detailing purchases made by a user at a first entity location, the user being a customer of the organization;
(iv) extracting, by the core analyzer of the system and from the transaction history database, the first transaction data set, the first transaction data set including data of the types identified based on the received analysis measures;
(v) accessing, by the core analyzer of the system, the transaction history database of the system for analyzing sequences in transaction data to obtain a second transaction data set detailing purchases made by the user at a second entity location within a maximum time of the purchases made in the first transaction data set at the first entity location and within a specified distance of the first entity location at which the purchases were made in the first transaction data set;
(vi) extracting, by the core analyzer of the system, the second transaction data set, the second transaction data set including data of the types identified based on the received analysis measures;
(vii) calculating, by the core analyzer of the system, a frequency with which the purchases in the first transaction data set are made within the maximum time and the specified distance of the purchases made in the second transaction data set by the user; and
(viii) generating, by the core analyzer of the system, an output with an indicator of the frequency with which the purchases in the first transaction data set are made within the maximum time and the specified distance of the purchases made in the second transaction data set by the user,
wherein the output is grouped to reflect changes in a usual frequency with which the purchases in the first transaction data set are made within the maximum time and the specified distance of the purchases made in the second transaction data set by the user to determine a relationship between the first transaction data set and the second transaction data set.

9. The method of claim 8 further comprising repeating steps (i) to (viii) for each user at the first entity location.

10. The method of claim 8 further comprising:
identifying, based on the output, a potential improvement for at least one of the first entity and the second entity; and
transmitting the identified potential improvement to at least one of the first entity and the second entity, wherein the potential improvement includes at least one of:
prospecting for new users of an entity and generating targeted notification for users.

11. The method of claim 8, wherein the specified distance is hard-wired into a memory associated with the system for analyzing sequences in transaction data of an organization.

12. The method of claim 8, wherein the maximum time is hard-wired into a memory associated with the system for analyzing sequences in transaction data of an organization.

13. The method of claim 8, wherein the maximum time is specified by a user.

14. The method of claim 8, wherein the specified distance is specified by a user.

15. A non-transitory computer-readable storage medium having computer-executable program instructions stored thereon that when executed by a processor, cause the processor to:
(i) receive transaction data for customers of the organization, the transaction data including transactions conducted at a plurality of entities;
(ii) receive analysis measures used to identify types of information within the transaction data for analysis;
(iii) access a transaction history database to obtain a first transaction data set detailing purchases made by a user at a first entity location, the user being a customer of the organization;
(iv) extract the first transaction data set, the first transaction data set including data of the types identified based on the received analysis measures;
(v) access the transaction history database to obtain a second transaction data set detailing purchases made by the user at a second entity location within a maximum distance of the purchases made in the first transaction data set at the first entity location and within a specified time of the purchases made in the first transaction data set at the first entity location;
(vi) extract, from the transaction history database, the second transaction data set, the second transaction data set including data of the types identified based on the received analysis measures;
(vii) calculate a frequency with which the purchases in the first transaction data set are made within the maximum distance and the specified time of the purchases made in the second transaction data set by the consumer; and
(viii) generate an output with an indicator of the frequency with which the purchases in the first transaction data set are made within the maximum distance and the specified time of the purchases made in the second transaction data set by the user,
wherein the output is grouped to reflect changes in a usual frequency with which the purchases in the first transaction data set are made within the specified time of the purchases made in the second transaction data set by the user to determine how the first transaction data set and the second transaction data set are related.

16. The computer-readable storage medium of claim 15, wherein the computer-executable instructions further perform: repeating steps (i) to (viii) for each consumer at the first entity location.

17. The computer-readable storage medium of claim 15, wherein the maximum distance is hard-wired into a memory associated with the processor.

18. The computer-readable storage medium of claim 15, wherein the maximum distance is provided by a user.

19. The computer-readable storage medium of claim 15, wherein information regarding the first entity, the second entity, and the maximum distance is provided by a user.

20. The computer-readable storage medium of claim 15, further including:
identifying, based on the output, a potential improvement for at least one of the first entity and the second entity; and
transmitting the identified potential improvement to at least one of the first entity and the second entity.
